(19) United States
(12) Patent Application Publication
(10) Pub. No.: US 2016/0304749 A1
(43) Pub. Date: Oct. 20, 2016

(54) Cyanoacrylate Adhesive Formulation And Method Of Making

(71) Applicant: Toagosei America Inc., West Jefferson, OH (US)

(72) Inventors: Hiroyuki Terai, Dublin, OH (US); Masanari Shinoda, Dublin, OH (US); Masafumi Yamamoto, Takaoka (JP)

(21) Appl. No.: 14/685,928

(22) Filed: Apr. 14, 2015

(51) Int. Cl. C09J 4/00; C09J 11/06; C09J 9/00

(52) U.S. Cl. CPC C09J 4/00; C09J 9/00; C09J 11/06; C08K 5/107

(57) ABSTRACT

A composition and method of making are provided for a cyanoacrylate adhesive formulation comprising a calixarene stabilizer which exhibits improved shelf life, as measured by aging and stability testing, while maintaining good bonding performance. One embodiment comprises ethyl-2-cyanoacrylate and 4-t-butylcalix[4]arene-tetraacetic acid tetraethyl ester as a stabilizer. A further embodiment comprises mixing a suitable cyanoacrylate with sufficient calixarene stabilizer to provide improved aging.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

This description relates generally to cyanoacrylate adhesive formulations and more particularly to cyanoacrylate adhesive formulations comprising calixarenes added to improve aging and stability of the formulation.

Cyanoacrylate adhesives are a general class of adhesives which are widely used and which cure quickly. Cyanoacrylate adhesives comprise cyanoacrylates, generally, [chemical formula: C₄H₂NO₂R, SMILES: N#C/C(═C)C(═O)OR where R is an alkyl having up to eight carbon atoms and include, among others, methyl cyanoacrylate [chemical formula: C₅H₅NO₂, SMILES: N#C/C(═C)C(═O)OC or COC(═O)C(═C)C#N]; ethyl cyanoacrylate (ethyl-2-cyanoacrylate) [chemical formula: C₆H₇NO₂, SMILES: N#CC(═C)C(═O)OCC]; propyl cyanoacrylate [chemical formula: C₇H₉NO₂, SMILES: CCCOC(═O)C(═C)C#N]; butyl cyanoacrylate [chemical formula: C₈H₁₁NO₂, SMILES: N#CC(═C)C(═O)OCCCC]; octyl cyanoacrylate [chemical formula: C₁₂H₁₉NO₂, SMILES: N#CC(C(OCCCCCCCC)═O)═C]; and 2-octyl cyanoacrylate [chemical formula: C₁₂H₁₉NO₂, SMILES: C═C(C#N)C(OC(C)CCCCCC)═O], isopropyl cyanoacrylate [chemical formula: C₇H₉NO₂, SMILES: C(#N)C(C(═O)OC(C)C)═C, CAS: 10586-17-1] isobutyl cyanoacrylate [chemical formula: C₈H₁₁NO₂, SMILES: N#CC═CC(═O)OCCC(C)C, CAS: 1069-55-2], and 2-ethoxyethyl cyanoacrylate [chemical formula: C₈H₁₁NO₃, SMILES: CCOC—COC(═O)C(═C)C#N, CAS: 21982-43-4]. In addition to formulations with a single cyanoacrylate, cyanoacrylate adhesives may contain two or more cyanoacrylates.

In addition to cyanoacrylates, cyanoacrylate adhesive formulations generally include various stabilizers to inhibit premature polymerization of the cyanoacrylate in the container, thickeners to control viscosity for ease of application and to help control bonding, and promoters to accelerate the rate of polymerization of the cyanoacrylates. Stabilizers include those to control anionic polymerization, such as boron trifluoride methanol complex (BF₃.CH₃OH) and sulfur dioxide (SO₂), as well as those to control radical polymerization, such as 2,2′-methylenebis(4-methyl-6-tert-butylphenol) [chemical formula: CH₂[C₆H₂[C(CH₃)₃](CH₃)OH]₂, SMILES: CC(C)(C)c1cc(c(c(c1)C(C)(C)C)O)Cc2cc(cc(c2O)C(C)(C)C)C(C)(C)C], hydroquinone (benzene-1,4 diol) [chemical formula: C₆H₄(OH)₂, SMILES: c1cc(ccc1O)O], t-butylcatechol [chemical formula: C₁₀H₁₄O₂, SMILES: CC(C)(C)c1ccc(c(c1)O)O], hydroquinone monomethyl ether (4-methyoxyphenol) [chemical formula: ((CH₃O)C₆H₄(OH)), CAS: 150-76-5, SMILES: COc1ccc(cc1)O], and pyrogallol (1,2,3-trihydroxybenzene) [chemical formula: (C₆H₄(OH)₃), SMILES: c1cc(c(c(c1)O)OOO, CAS: 87-66-1].

Thickeners include methyl methacrylate-methyl acrylate, acrylate resins such as poly(methyl methacrylate), poly(ethyl methacrylate), and poly(vinyl alkyl ethers) such as poly(vinyl methyl ether).

Promoters include 3- or 4-arm polyol podands (See, e.g., U.S. Pat. No. 4,386,193 to Reich et al. issued May 31, 1983), hydroxyl-terminated poly(dimethyl siloxane) [OH[Si)O(CH₃)₂]ₙ—H], poly(alkylene oxides, and so-called crown ethers. Crown ethers are of a class of cyclic compounds that consist of a ring containing a number of ether groups [R—O—R′, where R and R′ are organic radicals, generally carbon chains]. Crown ethers are designated as x-crown-y, where x=total number of atoms in the cyclic backbone and y=number of ether structures (oxygen atoms). Known crown ethers include, for example, 15-crown-5 [chemical formula: (C₂H₄O)₅, SMILES: C1COCCOCCOCCOCCO1] and 18-crown-6 [chemical formula: C₁₂H₂₄O₆, SMILES: C1CCOCCOCCOCCOCCOCC1 or C1COCCOCCOCCOCCOCCO1]. Finally, calixarenes have been used as promoters. Calixarenes are reported to provide substantially reduced fixture and cure times (See, e.g., U.S. Pat. No. 4,718,966 to Harris, et al. issued Jan. 12, 1988.) and as curing accelerators (See, e.g., U.S. Pat. No. 6,547,985 to Tajima et al. issued Apr. 15, 2003.).

While it is important to promote curing of cyanoacrylate adhesives, aging and stability are also important and can be in tension with promoting curing. In general, cyanoacrylate adhesives have a shelf life, if unopened, of about one year from manufacture and one month if opened. Aging can cause cyanoacrylate adhesives to thicken (increased viscosity) and cure more slowly. Control over increases in viscosity can improve the ability of the adhesive to withstand the effects of aging and stability and provide improved performance than would otherwise be expected. A formulation that is designed to a certain viscosity to provide good initial performance can provide improved performance after an extended shelf life if viscosity increases can be controlled. A typical aging test involves storing a container (e.g., 20 grams) of the adhesive formulation at a specified temperature and relative humidity for a specified period of time to predict shelf life. One aging test involves storing containers of the adhesive at 50 deg. C. and 95 percent relative humidity for between 4 and 10 weeks. Alternatively, containers of the adhesive are stored at 60 deg. C. for like periods of time. Samples are periodically removed from the aging environment and tested for viscosity, moisture, setting time, and adhesive strength. Stability testing involves gathering of more real-world shelf life data. For example, containers of the adhesive are stored at 25 deg. C. and 65 percent relative humidity for between 3 and 18 months. As with aging testing, samples are periodically removed from the stability testing environment and tested for viscosity, moisture, setting time, and adhesive strength. Setting time is defined as the time to cure to a bond that cannot be easily broken by hand.

Therefore, there is a need for a cyanoacrylate adhesive formulation that extends shelf life without sacrificing curing.

### BRIEF SUMMARY OF THE INVENTION

It has been surprisingly and unexpectedly found that calixarenes, when added to cyanoacrylate adhesive formulations in particular amounts, can, indeed, extend the shelf life, both aging and stability, without sacrificing curing performance. Various embodiments of the present invention include cyanoacrylate adhesive formulations comprising, by weight of the formulation, between about 80 percent to about 99.9 percent by weight of a suitable cyanoacrylate adhesive; sufficient amounts of suitable stabilizers; between about 0.1 to about 0.5 percent by weight of a suitable calixarene stabilizer; and, optionally, a suitable thickener.

In one embodiment, a cyanoacrylate adhesive formulation comprises, based upon the weight of the formulation, between about 80 percent to about 99.9 percent by weight of a suitable cyanoacrylate adhesive; between about 0.002 percent to about 0.01 percent by weight of a suitable stabilizer for anionic polymerization; between about 0.1 percent to about 0.3 percent by weight of a suitable stabilizer for radical polymerization; between zero percent to about 20 percent by weight of a suitable thickener; and between about 0.01 to about 0.5 percent by weight of a suitable calixarene stabilizer. The resulting adhesive formulation provides a Viscosity Change Ratio (VCR) of the formulation of less than about 2.5 following aging for 10 weeks at 50 deg. C. and 95 percent relative humidity, where VCR is defined as the viscosity after aging or stability testing divided by the initial viscosity. For example, if the viscosity after 4 weeks at 50 deg. C. and 95 percent relative humidity in a 20-gram container is 46.5 cps, and the initial viscosity was 45.0 cps, the VCR will be 1.03. As discussed above, control over increases in viscosity translate into improved shelf life and the ability to maintain cure performance over time.

In a further embodiment, the formulation comprises about 0.025 percent to about 0.25 percent by weight calixarene and the calixarene is 4-t-butylcalix[4]arene-tetraacetic acid tetraethyl ester.

In a further embodiment, the formulation comprises about 0.16 percent by weight 4-t-butylcalix[4]arene-tetraacetic acid tetraethyl ester.

In a further embodiment, the formulation retains the average steel tensile strength following aging for 10 weeks at 50 deg. C. and 95 percent relative humidity compared with the initial average steel tensile strength.

In a further embodiment, the formulation retains 90 percent of the average steel tensile strength following aging for 10 weeks at 60 deg. C.

In a further embodiment, the formulation retains the average steel tensile strength following stability testing for 18 months at 25 deg. C. and 65 percent relative humidity.

In a further embodiment, a composition of matter comprises, based upon the weight of the composition of matter, between about 80 percent to about 99.9 percent by weight of a suitable cyanoacrylate and between about 0.1 to about 0.5 percent by weight of a suitable calixarene stabilizer, wherein the Viscosity Change Ratio of the formulation satisfies at least one of: less than about 3.5 following aging for 10 weeks at 50 deg. C. and 95 percent relative humidity; and less than about 3.5 following aging for 10 weeks at 60 deg. C.

In a further embodiment, the composition of matter comprises about 91.5 percent by weight cyanoacrylate and the cyanoacrylate is ethyl-2-cyanoacrylate.

In a further embodiment, wherein the composition of matter comprises about 0.16 by weight calixarene and the calixarene is 4-t-butylcalix[4]arene-tetraacetic acid tetraethyl ester.

In a further embodiment, the Viscosity Change Ratio of the composition of matter satisfies at least one of: less than about 1.2 following aging for 4 weeks at 50 deg. C. and 95 percent relative humidity; less than about 1.2 following aging for 6 weeks at 50 deg. C. and 95 percent relative humidity; less than about 1.5 following aging for 8 weeks at 50 deg. C. and 95 percent relative humidity; less than about 4.0 following aging for 10 weeks at 50 deg. C. and 95 percent relative humidity; less than about 1.3 following aging for 4 weeks at 60 deg. C.; less than about 1.6 following aging for 6 weeks at 60 deg. C.; less than about 1.8 following aging for 8 weeks at 60 deg. C.; and less than about 3.5 following aging for 10 weeks at 60 deg. C.

In a further embodiment, the formulation retains the average steel tensile strength following aging for 10 weeks at 50 deg. C. and 95 percent relative humidity compared with the initial average steel tensile strength.

In a further embodiment, the composition of matter retains 90 percent of the average steel tensile strength following aging for 10 weeks at 60 deg. C.

In a further embodiment, the composition of matter retains the average steel tensile strength following stability testing for 18 months at 25 deg. C. and 65 percent relative humidity.

In a further embodiment, a process of preparing a cyanoacrylate adhesive formulation comprises the step of: mixing between about 80 percent to about 99.9 percent, by weight of the formulation, of a suitable cyanoacrylate with between about 0.01 and 0.5 percent by weight of the formulation of a suitable calixarene, wherein the Viscosity Change Ratio for the formulation satisfies at least one of: less than about 3.5 following aging for 10 weeks at 50 deg. C. and 95 percent relative humidity; and less than about 3.5 following aging for 10 weeks at 60 deg. C.

In a further embodiment, the process includes ethyl-2-cyanoacrylate as a cyanoacrylate and 4-t-butylcalix[4]arene-tetraacetic acid tetraethyl ester as a calixarene.

In a further embodiment, the process provides a formulation where the Viscosity Change Ratio of the formulation satisfies at least one of: less than about 1.2 following aging for 4 weeks at 50 deg. C. and 95 percent relative humidity; less than about 1.2 following aging for 6 weeks at 50 deg. C. and 95 percent relative humidity; less than about 1.5 following aging for 8 weeks at 50 deg. C. and 95 percent relative humidity; less than about 4.0 following aging for 10 weeks at 50 deg. C. and 95 percent relative humidity; less than about 1.3 following aging for 4 weeks at 60 deg. C.; less than about 1.6 following aging for 6 weeks at 60 deg. C.; less than about 1.8 following aging for 8 weeks at 60 deg. C.; and less than about 3.5 following aging for 10 weeks at 60 deg. C.

In a further embodiment, the process provides a formulation which retains the average steel tensile strength following aging for 10 weeks at 50 deg. C. and 95 percent relative humidity compared with the initial average steel tensile strength.

In a further embodiment, the process provides a formulation which retains 90 percent of the average steel tensile strength following aging for 10 weeks at 60 deg. C.

In a further embodiment, the process provides a formulation which retains the average steel tensile strength following stability testing for 18 months at 25 deg. C. and 65 percent relative humidity.

### BRIEF DESCRIPTION OF THE SEVERAL FIGURES

FIG. 1 is Table 2 and shows Initial Formulation Data for eight embodiments (Formulation Embodiments, FE) and two Conventional Formulations (CF).

FIG. 2 is Table 3 and shows results for an Aging Test at 50 deg. C. and 95 percent relative humidity with a 20-gram container for eight Formulation Embodiments and two Conventional Formulations.

FIG. 3 is Table 4 and shows results for an Aging Test at 60 deg. C. with a 20-gram container for eight Formulation Embodiments and two Conventional Formulations.

FIG. 4 is Table 5 and shows results for a Stability Test at 25 deg. C. and 65 percent relative humidity with a 20-gram container for one Formulation Embodiment and two Conventional Formulations.

In describing the various embodiments of the invention, specific terminology will be resorted to for the sake of clarity. However, it is not intended that the invention be limited to the specific term(s) so selected and it is to be understood that each specific term includes all technical equivalents which operate in a similar manner to accomplish a similar purpose.

### DETAILED DESCRIPTION OF THE INVENTION

Illustrative embodiments of the present invention along with two conventional formulations for comparison are shown is Table 1 below.

TABLE 1

| | Composition (% w/w) | | | | | | | | | |
|---|---|---|---|---|---|---|---|---|---|---|
| Component | FE1 | FE2 | FE3 | FE4 | FE5 | FE6 | FE7 | FE8 | CF1 | CF2 |
| Ethyl-2-Cyanoacrylate | 91.5 | 91.5 | 91.5 | 91.5 | 91.5 | 91.5 | 91.5 | 91.5 | 91.5 | 97.8 |
| Boron Trifluoride Methanol Complex | 0.004 | 0.004 | 0.004 | 0.006 | 0.004 | 0.004 | 0.004 | 0.004 | 0.004 | — |
| Sulfur Dioxide | — | — | 0.002 | — | — | — | — | — | — | 0.004 |
| 2,2′-Methylenebis(4-methyl-6-tert-butylphenol) | 0.1 | 0.2 | 0.1 | 0.1 | 0.2 | 0.2 | 0.2 | 0.2 | 0.2 | 0.12 |
| Hydroquinone | 0.06 | — | 0.06 | 0.06 | — | — | — | — | — | 0.06 |
| Methyl Methacrylate-Methyl Acrylate | 8.5 | 8.5 | 8.5 | 8.5 | 8.5 | 8.5 | 8.5 | 8.5 | 8.5 | — |
| (MMA-MA copolymer) | | | | | | | | | | |
| Poly(Methyl Methacrylate) | — | — | — | — | — | — | — | — | — | 2.2 |
| (PMMA) | | | | | | | | | | |
| 4-t-Butyl-calix[4]arene-tetraacetic | 0.16 | 0.16 | 0.16 | 0.16 | 0.25 | 0.10 | 0.05 | 0.025 | — | — |
| acid tetraethyl ester | | | | | | | | | | |
| 15-Crown-5 | — | — | — | — | — | — | — | — | 0.16 | — |
| 18-Crown-6 | — | — | — | — | — | — | — | — | — | 0.01 |

Data are expressed in weight percent (% w/w). Embodiments of the present invention are listed as Formulation Embodiments (FE), while conventional formulations, included for comparison purposes only, are listed as Conventional Formulations (CF).

While ethyl-2-cyanoacrylate is used in the illustrated embodiments, and at 91.5% w/w, as discussed above, numerous cyanoacrylates, and combinations of cyanoacrylates are also suitable candidates for embodiments of the present invention, as are other concentrations of the cyanoacrylate.

Similarly, while boron trifluoride methanol complex and sulfur dioxide are included as anionic polymerization stabilizers, and at the indicated proportions, other anionic polymerization stabilizers at other proportions are also possible.

Table 1 lists 2,2′-methylenebis(4-methyl-6-tert-butylphenol) and hydroquinone as radical polymerization stabilizers at the indicated proportions. However, other radical polymerization stabilizers at other proportions are also possible.

As further shown in Table 1, two exemplary thickeners are included, methyl methacrylate-methyl acrylate (Delpowder 70H™ from Asahi Kasei has been used with good results) and poly(methyl methacrylate) (Acrycon AC™ from Mitsubishi Rayon has been used with good results) at the indicated proportions. Other thickeners at other proportions are also possible.

Finally, a calixarene, 4-t-butylcalix[4]arene-tetraacetic acid tetraethyl ester, has been added which provides enhanced stability as discussed above. As shown in Table 1, the proportion of the indicated calixarene ranges from 0.025% w/w (FE8) to 0.16% w/w (FE1-FE7).

Shown in Table 1 for comparison are two crown ethers, 15-crown-5 and 18-crown-6, which are typically used as promoters.

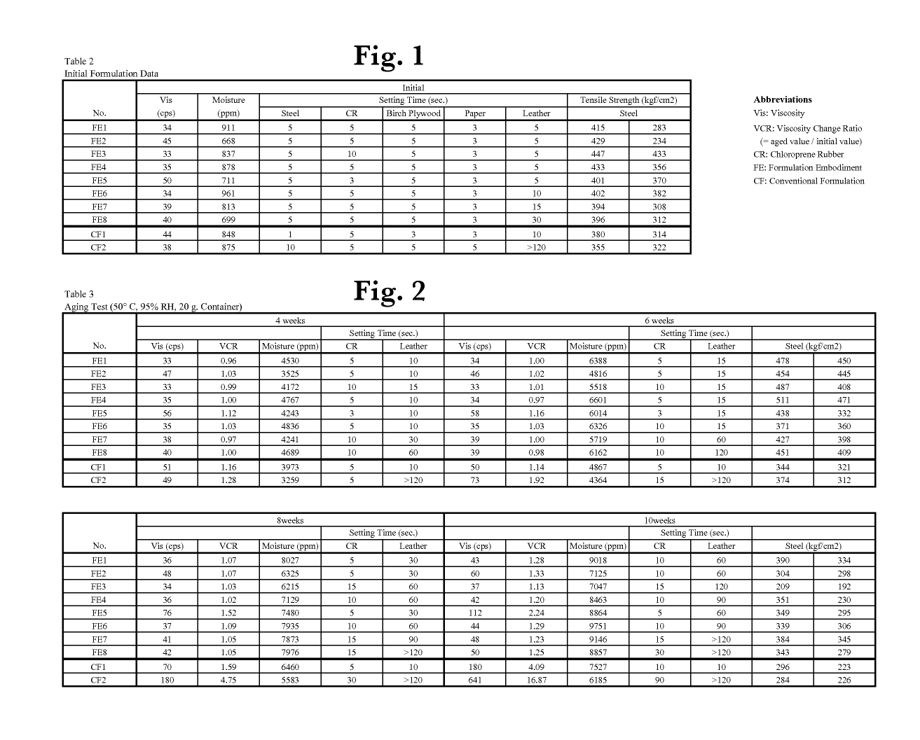

Turning now to FIG. 1, Table 2 shows Initial Formulation Data for the formulations listed in Table 1. Looking first at viscosity, these tests were performed under ASTM D 1084-97 (Reapproved 2005), entitled Standard Test Methods for Viscosity of Adhesives. Looking next at Setting Time, the times for steel for FE1-FE8 are consistent at five seconds. The performance for steel of CF1 and CF2 are affected by the proportions of the crown ethers. Looking at chloroprene rubber (CR), a peel test, while not wishing to be bound by any particular theory, the setting time for FE3 may be higher due to the presence of sulfur dioxide. The results for FE1-FE8 for birch plywood, a tensile shear test, are all comparable. The results for FE1-FE8 for paper, a tensile shear test, are all comparable. The results for leather, a tensile shear test, are comparable for FE1-FE5. While not wishing to be bound by any particular theory, it is possible that the presence of lower levels of the calixarene account for the difference. Finally, Initial Test Data are shown for tensile testing of steel under ASTM D 2095-96 (Reapproved 2002), entitled Standard Test Method for Tensile Strength of Adhesives by Means of Bar and Rod Specimens.

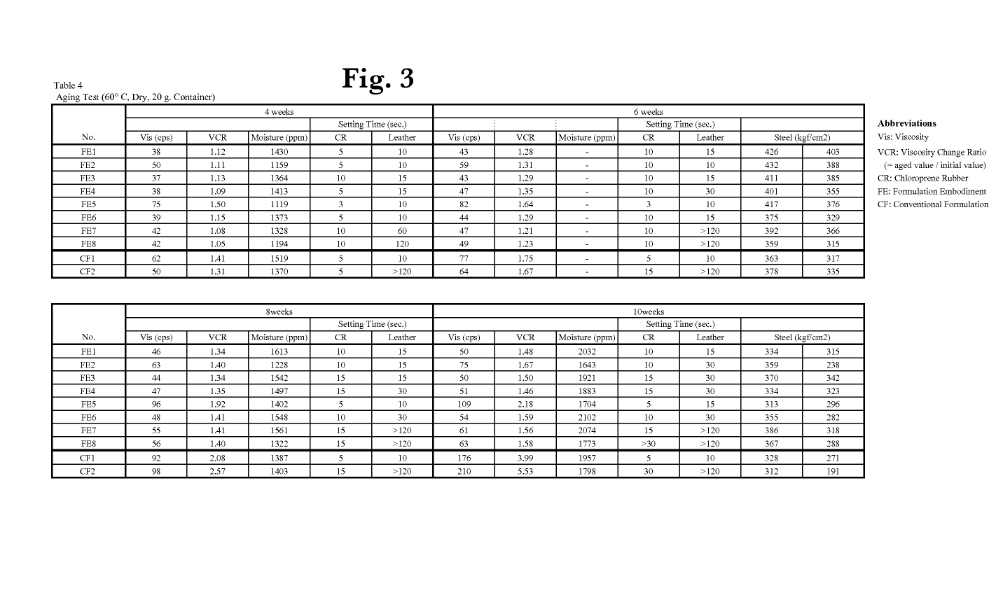

Turning now to FIG. 2, Table 3 shows Aging Test data at 50 Deg. C and 95 percent relative humidity. As discussed above, control over viscosity changes (VCR) can have a marked effect on shelf life. At four weeks, as Table 3 clearly shows, FE1-FE8, containing the calixarene, all exhibit significantly better VCR values than CF1 or CF2.

Setting Time for chloroprene rubber shows little, if any degradation, but for FE7 and FE8. While not wishing to be bound by any particular theory, it is possible that the presence of lower levels of the calixarene account for the differences shown.

Looking now at Table 3 at six weeks, FE1-FE8, containing the calixarene, all continue to exhibit significantly better VCR performance than CF1 or CF2. Good results are shown for Setting Time for chloroprene rubber. Finally, the tensile test results for steel indicate improved bond strength over the values in the Initial Data shown in FIG. 1, Table 2.

Looking now at Table 3 at eight weeks, FE1-FE8, containing the calixarene, all continue to exhibit significantly better VCR values than CF1 or CF2. Possibly due to the increased proportion of the calixarene in FE5, the VCR value is higher than the other FE formulations.

Looking now at Table 3 at ten weeks, FE1-FE8, containing the calixarene, all continue to exhibit significantly better VCR values than CF1 or CF2. As with the results at four, six, and eight weeks, FE5 shows a higher VCR value, possible due to the increased proportion of the calixarene in that formulation.

Turning now to FIG. 3, Table 4 shows Aging Test data at 60 Deg. C. FE1-FE8 show consistently better VCR values than CF1 or CF2. The tensile test results for FE1 and FE2 for steel indicate improved bond strength over the values in the Initial Data shown in FIG. 1, Table 2 and over the values shown for CF1 and CF2 Likewise, all FE formulations but FE5, discussed above, indicate better VCR values than CF1 and CF2 at ten weeks.

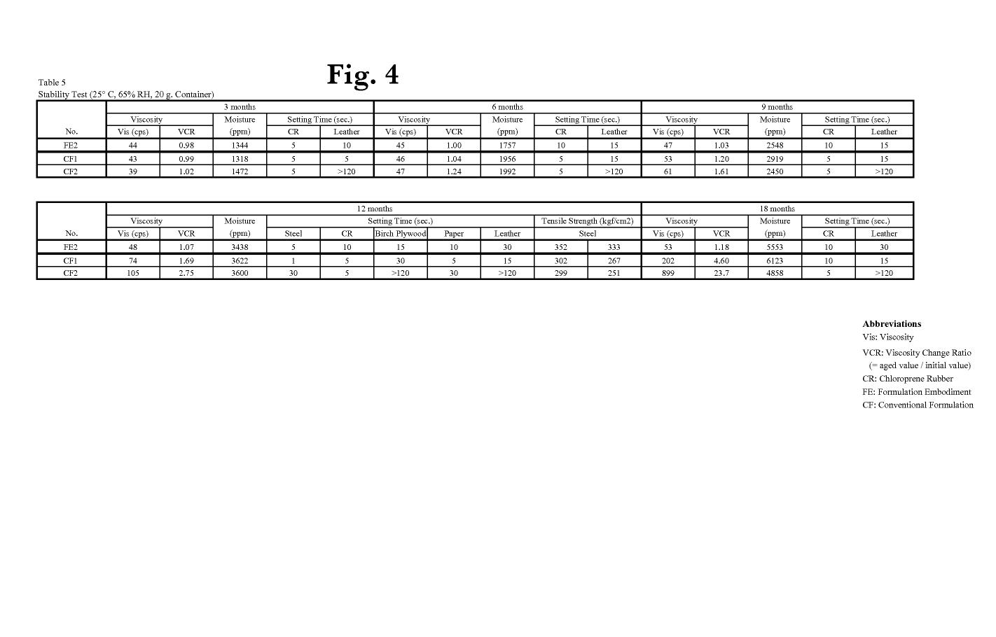

Turning now to FIG. 4, Table 5 shows Stability Test data at 25 deg. C. and 65 percent relative humidity. As shown, FE2 gives consistently better results than both CF1 and CF2 in nearly all categories over the entire time period.

Thus, the addition of a calixarene, a known promoter, unexpectedly provides improved shelf life while maintaining good bonding performance.

This detailed description in connection with the figures is intended principally as a description of the presently preferred embodiments of the invention, and is not intended to represent the only forms in which the present invention may be formulated or produced. The description sets forth the formulations and processes of making those formulations in connection with the described embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. The composition of matter of claim 11, wherein the composition of matter further comprises:
between about 0.1 percent to about 0.3 percent by weight of a suitable stabilizer for radical polymerization; and
between zero percent to about 20 percent by weight of a suitable thickener.

2. The composition of matter of claim 11, wherein the Initial Setting Time for chloroprene rubber is less than about 5 seconds.

3. The composition of matter of claim 11, wherein the Initial Setting Time for leather is less than about 5 seconds.

4. The composition of matter of claim 11, wherein the cyanoacrylate is chosen from the list consisting essentially of methyl cyanoacrylate, ethyl cyanoacrylate, butyl cyanoacrylate, octyl cyanoacrylate, 2-octyl cyanoacrylate, isopropyl cyanoacrylate, isobutyl cyanoacrylate, and 2-ethoxyethyl cyanoacrylate.

5. The composition of matter of claim 11, wherein the composition of matter comprises between about 90 percent to about 99.9 percent by weight cyanoacrylate and the cyanoacrylate is ethyl-2-cyanoacrylate.

6. The composition of matter of claim 11, wherein the composition of matter comprises about 0.025 percent to about 0.25 percent by weight calixarene stabilizer and the calixarene stabilizer is 4-t-butylcalix[4]arene-tetraacetic acid tetraethyl ester.

7. The composition of matter of claim 6, wherein the composition of matter comprises about 0.16 percent by weight 4-t-butylcalix[4]arene-tetraacetic acid tetraethyl ester.

8. The composition of matter of claim 6, wherein the composition of matter retains the average steel tensile strength following aging for 10 weeks at 50 deg. C. and 95 percent relative humidity compared with the initial average steel tensile strength.

9. The composition of matter of claim 6, wherein the composition of matter retains 90 percent of the average steel tensile strength following aging for 10 weeks at 60 deg. C.

10. The composition of matter of claim 6, wherein the composition of matter retains the average steel tensile strength following stability testing for 18 months at 25 deg. C. and 65 percent relative humidity.

11. A composition of matter, comprising, based upon the weight of the composition of matter:
between about 80 percent to about 99.9 percent of a suitable cyanoacrylate; between about 0.002 percent to about 0.01 percent of a suitable stabilizer for anionic polymerization; and
between about 0.1 to about 0.5 percent of a suitable calixarene stabilizer, wherein the Viscosity Change Ratio of the formulation satisfies at least one of:
less than about 1.2 following aging for four weeks at 50 deg. C. and 95 percent relative humidity;
less than about 1.2 following aging for six weeks at 50 deg. C. and 95 percent relative humidity;
less than about 1.5 following aging for eight weeks at 50 deg. C. and 95 percent relative humidity;
less than about 2.5 following aging for 10 weeks at 50 deg. C. and 95 percent relative humidity;
less than about 3.5 following aging for 10 weeks at 50 deg. C. and 95 percent relative humidity;
less than about 4.0 following aging for 10 weeks at 50 deg. C. and 95 percent relative humidity;
less than about 1.3 following aging for four weeks at 60 deg. C.;
less than about 1.6 following aging for six weeks at 60 deg. C.;
less than about 1.8 following aging for eight weeks at 60 deg. C.; and
less than about 3.5 following aging for 10 weeks at 60 deg. C.

12. The composition of matter of claim 5, wherein the composition of matter comprises about 91.5 percent by weight ethyl-2-cyanoacrylate.

13-17. (canceled)

18. A process of preparing a cyanoacrylate adhesive formulation, comprising the step of:
(a) mixing between about 80 percent to about 99.9 percent, by weight of the formulation, of a suitable cyanoacrylate with between about 0.01 and 0.5 percent by weight of the formulation of a suitable calixarene, wherein the Viscosity Change Ratio for the formulation satisfies at least one of:
less than about 3.5 following aging for 10 weeks at 50 deg. C. and 95 percent relative humidity; and
less than about 3.5 following aging for 10 weeks at 60 deg. C. [Question: The spreadsheet just says “dry”. Is there a RH value associated with “dry”?]

19. The process of claim 18, wherein:
the cyanoacrylate is ethyl-2-cyanoacrylate; and
the calixarene is 4-t-butylcalix[4]arene-tetraacetic acid tetraethyl ester.

20. The process of claim 18, wherein the Viscosity Change Ratio of the formulation satisfies at least one of:
less than about 1.2 following aging for 4 weeks at 50 deg. C. and 95 percent relative humidity;
less than about 1.2 following aging for 6 weeks at 50 deg. C. and 95 percent relative humidity;
less than about 1.5 following aging for 8 weeks at 50 deg. C. and 95 percent relative humidity;
less than about 4.0 following aging for 10 weeks at 50 deg. C. and 95 percent relative humidity;
less than about 1.3 following aging for 4 weeks at 60 deg. C.;
less than about 1.6 following aging for 6 weeks at 60 deg. C.;
less than about 1.8 following aging for 8 weeks at 60 deg. C.; and
less than about 3.5 following aging for 10 weeks at 60 deg. C.

21. The process of claim 20, wherein the formulation retains the average steel tensile strength following aging for 10 weeks at 50 deg. C. and 95 percent relative humidity compared with the initial average steel tensile strength.

22. The process of claim 20, wherein the formulation retains 90 percent of the average steel tensile strength following aging for 10 weeks at 60 deg. C.

23. The process of claim 20, wherein the formulation retains the average steel tensile strength following stability testing for 18 months at 25 deg. C. and 65 percent relative humidity.
